(19) United States
(12) Patent Application Publication
(10) Pub. No.: US 2012/0243227 A1
(43) Pub. Date: Sep. 27, 2012

(54) LIGHT-EMITTING MODULE, LIGHT-EMITTING MODULE UNIT, AND LUMINAIRE

(75) Inventors: Keiichi SHIMIZU, Yokosuka-shi (JP); Hiroaki Watanabe, Yokosuka-shi (JP); Takafumi Oishi, Yokosuka-shi (JP); Kenji Sugiyama, Yokosuka-shi (JP)

(73) Assignee: Toshiba Lighting & Technology Corporation, Kanagawa (JP)

(21) Appl. No.: 13/420,495

(22) Filed: Mar. 14, 2012

(30) Foreign Application Priority Data
Mar. 23, 2011 (JP) 2011-065057
Mar. 23, 2011 (JP) 2011-065058

(51) Int. Cl. F21S 4/00

(52) U.S. Cl. 362/249.01

(57) ABSTRACT

According to one embodiment, a light-emitting module includes a substrate and a light-emitting element mounted on the substrate. One side of the light-emitting module has a length of 160 mm to 200 mm. An optical output per area for a square section of the light-emitting module having a side length equal to the length of the one side is 700 lm to 1300 lm, and a rated power consumption of the square section is equal to or less than 16 W. A plurality of such light-emitting modules are arranged and combined to form various luminaires having shapes and lighting performances equivalent to a shape and lighting performance of a luminaire including a fluorescent lamp as a light source.

### INCORPORATION BY REFERENCE

The present invention claims priority under 35 U.S.C. §119 to Japanese Patent Application Nos. 2011-065057 and 2011-065058 filed on Mar. 23, 2011 and Mar. 23, 2011, respectively. The contents of these applications are incorporated herein by reference in their entirety.

### FIELD

Embodiments described herein relate generally to a light-emitting module using light-emitting elements and a light-emitting module unit and a luminaire using the light-emitting module.

### BACKGROUND

Recently, according to the increase in output, the improvement of efficiency, and the spread of LEDs, a luminaire using an LED as a light source and used indoor or outdoor is developed. In the luminaire, plural LEDs are mounted on a substrate to form an LED module and a predetermined light amount is obtained by light emitted from the LED module. For example, the luminaire is used as a base light attached to the ceiling surface or the like of an office and used as general lighting in the office.

However, the LED module in the luminaire is less easily used in common in various luminaires. Therefore, it is difficult to apply the LED module to the various luminaires.

Therefore, there is a demand for development of a light-emitting module that can be used in common in various luminaires and a light-emitting module unit and a luminaire using the light-emitting module.

### BRIEF DESCRIPTION OF THE DRAWINGS

FIG. 1 is a front view of an LED module according to a first embodiment;

FIG. 2 is a front view of a state in which a plurality of the LED modules are disposed in a laterally long rectangular shape;

FIG. 3 is a front view of a state in which the plurality of the LED modules are disposed in a square shape;

FIG. 4 is a perspective view of a luminaire in which the LED modules are disposed;

FIG. 5 is a disassembled perspective view of the luminaire;

FIG. 6 is a front view of the luminaire from which a cover member is removed;

FIG. 7 is a perspective view of an LED module unit using the LED module;

FIG. 8 is a perspective view of an attachment configuration of the LED module;

FIG. 9 is a perspective view of another attachment configuration (an example 1) of the LED module;

FIG. 10 is a perspective view of still another attachment configuration (an example 2) of the LED module;

FIG. 11 is a perspective view of still another attachment configuration (an example 3) of the LED module;

FIG. 12 is a perspective view of still another attachment configuration (an example 4) of the LED module;

FIG. 13 is a perspective view of still another attachment configuration (an example 5) of the LED module;

FIG. 14 is a connection diagram of a connection state in the still another attachment configuration (the example 5) of the LED module;

FIG. 15 is a plan view of an LED module according to a second embodiment;

FIGS. 16(a) and 16(b) are diagrams of a state in which a plurality of the LED modules are disposed, wherein FIG. 16(a) is a front view of a state in which the plurality of the LED modules are disposed in a laterally long rectangular shape and FIG. 16(b) is a front view of a state in which the plurality of the LED modules are disposed in a square shape;

FIG. 17 is a front view of an LED module according to a third embodiment;

FIGS. 18(a), 18(b) and 18(c) are diagrams of a state in which a plurality of the LED modules are disposed, wherein FIG. 18(a) is a front view of a state in which the plurality of the LED modules are disposed in a laterally long rectangular shape and FIGS. 18(b) and 18(c) are front views of a state in which the plurality of the LED modules are disposed in a square shape; and

FIG. 19 is a perspective view of an attachment configuration of an LED module according to a fourth embodiment.

### DETAILED DESCRIPTION

In general, according to one embodiment, a light-emitting module includes a substrate and light-emitting elements mounted on the substrate. A unit dimension of the light-emitting module is 160 mm to 200 mm. An optical output per a square having the unit dimension as a length dimension is 700 lm to 1300 lm. Rated power consumption is equal to or less than 16 W. The numbers and the arrangements of the light-emitting modules are combined to form various luminaires having shapes and lighting performances equivalent to a luminaire including a fluorescent lamp as a light source. Consequently, it is possible to provide the light-emitting module that can be used in common in the luminaires.

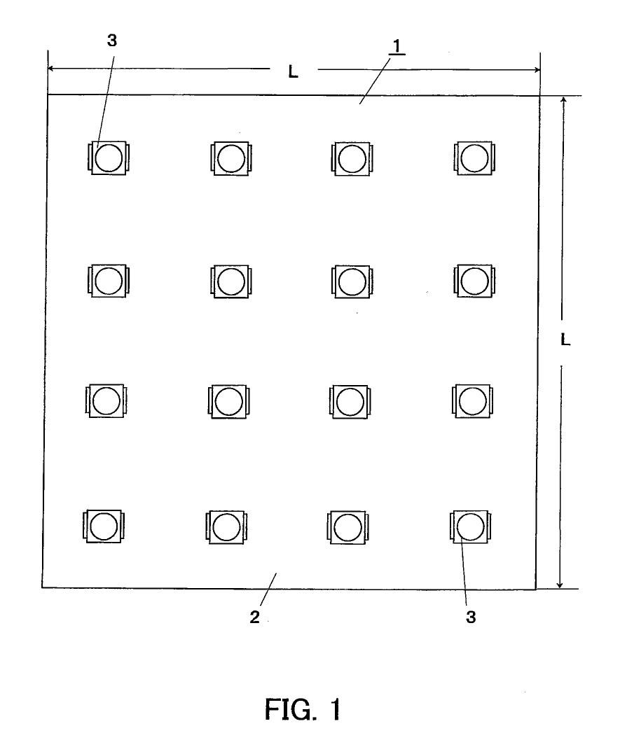

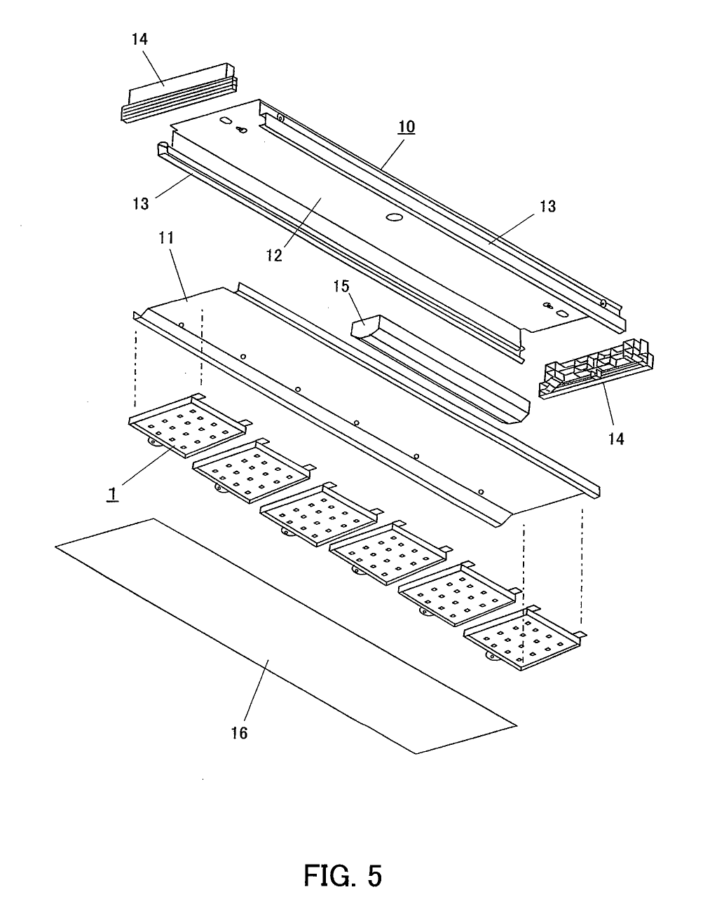

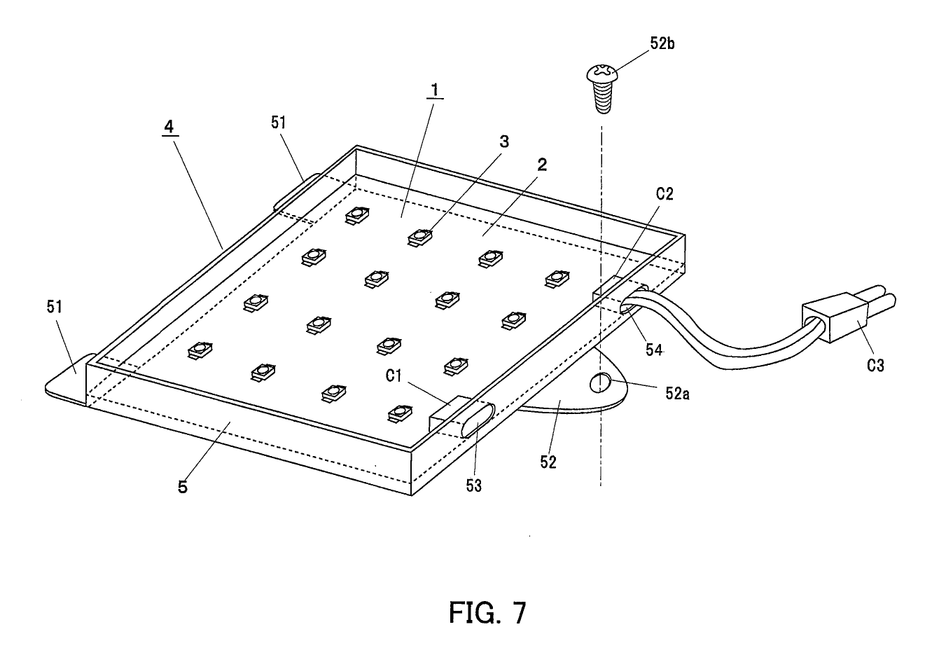

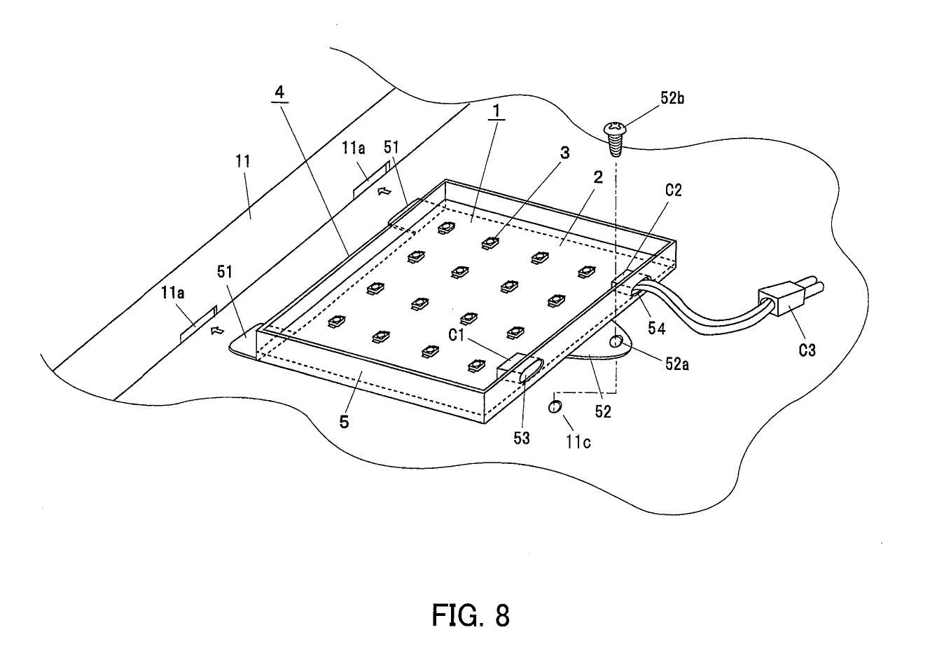

A first embodiment is explained with reference to FIGS. 1 to 14. FIGS. 1 to 3 and FIG. 7 are diagrams of an LED module. FIGS. 4 to 6 are diagrams of a luminaire in which LED modules are disposed. FIG. 7 is a diagram of an LED module unit. FIGS. 8 to 14 are diagrams of examples of specific attachment configurations of the LED modules to a luminaire. In the figures, the same components are denoted by the same reference numerals and signs and redundant explanation of the components is omitted.

The front surface side of an LED module 1 functioning as a light-emitting module is shown in FIG. 1. The LED module 1 includes a substrate 2 and plural LEDs 3 functioning as light-emitting elements mounted on the substrate 2. The LED module 1 is formed in a substantially square shape. A length dimension of one side of the LED module 1 is set to 200 mm+0% to −20%, i.e., a unit dimension L of the one side is set to 160 mm to 200 mm.

Specifically, the substrate 2 is made of a flat plate of glass epoxy resin, which is an insulating material, and is formed in a substantially square shape having a length dimension of one side set to 160 mm to 200 mm. A wiring pattern formed of a copper foil is applied to the front surface side of the substrate 2. Further, a white resist layer is applied to the front surface side as appropriate.

When the material of the substrate 2 is the insulating material, a ceramics material or a synthetic resin material can be applied. When the substrate 2 is made of metal, a base substrate of metal obtained by superimposing an insulating layer on one surface of a base plate having high heat conductivity and excellent in heat dissipation such as aluminum can be applied.

The LED 3 is an LED package of a surface mounting type. Schematically, the LED 3 includes an LED chip disposed on a main body formed of ceramics or synthetic resin and translucent resin for mold such as epoxy resin or silicone resin for sealing the LED chip.

The LED chip is a blue LED chip that emits blue light. A phosphor is mixed in the translucent resin. As the phosphor, a yellow phosphor that is in a complementary color relation with the blue light and emits yellowish light is used to make it possible to emit white light.

As the LED 3, the LED chip may be directly mounted on the substrate 2. A shell-type LED may be mounted. A mounting type and a form are not specifically limited.

In the LED module 1 configured in this way, an optical output is designed to be 700 lm to 1300 lm and rated power consumption is designed to be equal to or less than 16 W. In other words, an optical output per a square having a unit dimension L (160 mm to 200 mm) as a length dimension of one side is designed to be 700 lm to 1300 lm and rated power consumption per the square having the unit dimension L as the length dimension of one side is designed to be equal to or less than 16 W. The LED module 1 is configured to be easily used in common in various luminaires in terms of size and performance.

A technical ground in designing the LED module 1 is explained. Basically, the LED module 1 is grounded on a design idea for satisfying compatibility with the existing fluorescent lamps in terms of performance.

### [Size of the LED Module]

The size and the shape of a luminaire using a fluorescent lamp as a light source most widely spread as office lighting in the present situation is the size and the shape of a laterally long rectangular base light based on a 4-feet (about 1200 mm) size and the size and the shape of a square base light based on a 600 mm size.

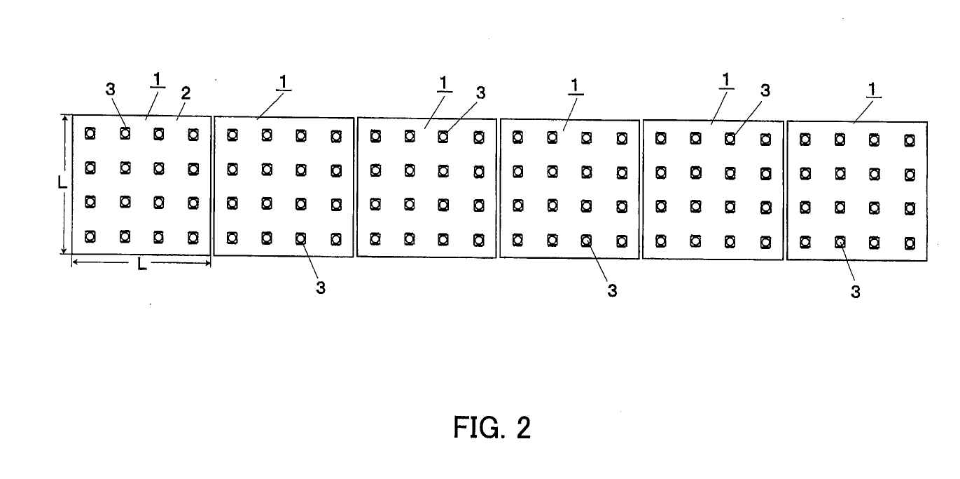

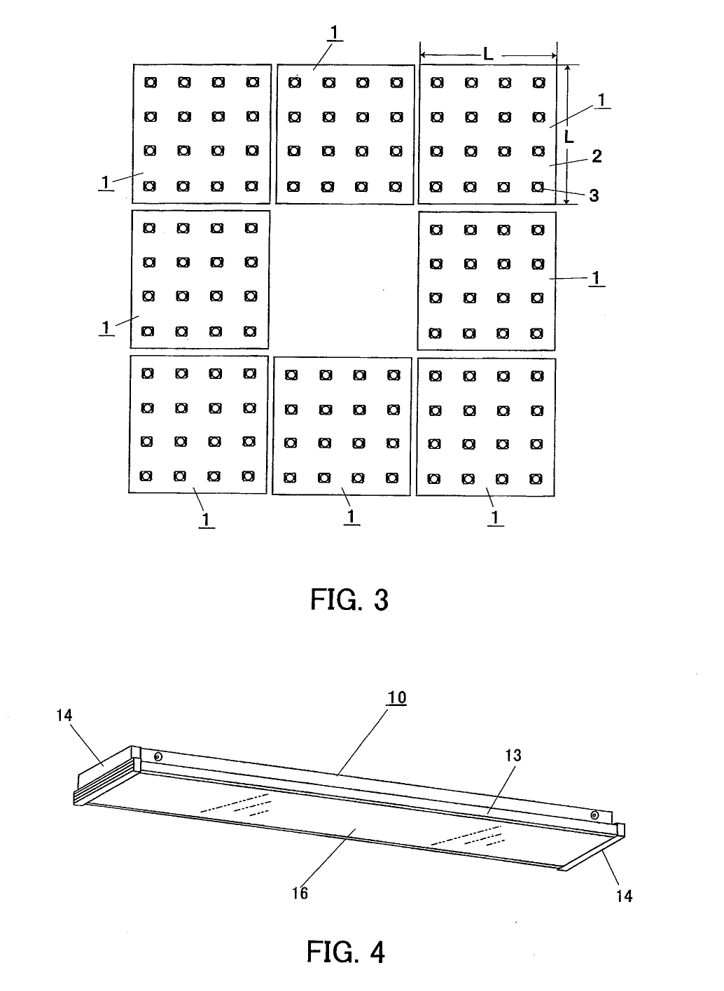

In order to adapt the LED module to luminaires having both the sizes, in the laterally long rectangular base light, as shown in FIG. 2, six LED modules 1 are arranged in a longitudinal direction and, in the square base light, as shown in FIG. 3, eight LED modules 1 are arranged in a quadrangular shape. In this case, it is suitable to use, in terms of size, the LED module 1 having a square shape, a length dimension of one side of which is set to 200 mm.

However, actually, for example, in plural arranged modules LED 1, it is likely that a separation dimension α such as a gap caused by a gap due to a coupling structure or a detailed structure of a luminaire occurs between sides opposed to each other between the LED modules 1 adjacent to each other. Therefore, the length dimension of one side of the LED module 1 is set to 200 mm-α. A percentage of occurrence of the separation dimension α is considered to be about 20% at the maximum structurally. Therefore, the length dimension of one side of the LED module 1 is 200 mm+0% to −20%. As a conclusion, the unit dimension L is 160 mm to 200 mm.

### [Optical Output (Luminous Flux) of the LED Module]

As a premise of a luminous flux of a fluorescent lamp used in a luminaire, the luminous flux is adapted to a range of 3000 lm of FLR type (rapid start type) rated lamp power 40 W to 4950 lm (45 W at high-power lighting time) of Hf type (high-frequency exclusive lighting type) rated lamp power 32 W.

Japan Electric Lamp Manufactures Association of bulb standard JEL801 “a straight tube type LED lamp system with an L type pin cap GX16t-5” indicates that a luminous flux of 2300 lm is necessary in a straight tube type LED lamp in order to secure illuminance of the same degree as FLR type 40 W (luminous flux of 3000 lm).

According to JEL801, in order to adapt the LED module to illuminance equivalent to the illuminance of a luminaire for two fluorescent lamps, a luminous flux of 4600 lm is necessary in an LED lamp as opposed to a luminous flux of FLR type 40 W (luminous flux of 3000 lm)×two lamps.

Therefore, since six LED modules 1 share the luminous flux of 4600 lm, a luminous flux per one LED module 1 is 4600 lm/6≈770 lm.

On the other hand, in the case of a luminous flux of Hf type 32 W (luminous flux of 4950 lm)×two lamps, similarly, according to JEL801, a luminous flux per one LED module 1 is 4950 lm×2×(2300 lm/3000 lm)/6≈1265 lm.

Therefore, as a range of a luminous flux per one LED module 1 for adapting the LED module 1 to the illuminance equivalent to the luminaire for two fluorescent lamps, a luminous flux of about 700 lm to 1300 lm is appropriate and a luminous flux of 770 lm to 1300 lm is more suitable.

### [Efficiency of the LED Module]

In FLR type 40 W of the fluorescent lamp, since a luminous flux is 3000 lm and rated lamp power is 40 W, efficiency is 3000 lm/40 W=75 m/W. When this efficiency as a reference is converted into efficiency in the case of the LED module 1, (75 lm/W)×(2300 lm/3000 lm)≈58 lm/W is derived.

At Hf type 32 W, since a luminous flux is 3520 lm and rated lamp power is 32 W, efficiency is 3520 lm/32 W=110 lm/W. When this efficiency as a reference is converted into efficiency in the case of the LED module 1, (110 lm/W)×(2300 lm/3000 lm)≈84 lm/W is derived.

A luminaire using the LED module 1 has an appointed task of replacing a luminaire using a high-efficiency Hf type fluorescent lamp. Therefore, a high efficiency value of 84 lm/W adapted to the Hf type fluorescent lamp is adopted as a reference value.

### [Power Consumption of the LED Module]

As explained above, from the range 770 lm to 1300 lm of a luminous flux per one LED module 1 and the reference value 841 lm/W of efficiency, power consumption in the case of the luminous flux of 770 lm is 770 lm/(84 lm/W)≈9.2 W and power consumption in the case of the luminous flux of 1300 lm is 1300 lm/(84 lm/W)≈15.5 W.

Therefore, it is suitable that power consumption is about 9 W to 16 W and rated power consumption is equal to or less than 16 W.

### [Temperature Rise of the LED Module]

When the LED module 1 is energized and the LED 3 emits light, temperature rises and heat is generated. The thermal radiation of the LED module 1 is mainly radiation from the surface (an LED mounting surface) of the LED module 1. A slight convection current acts on the surface. Under such a condition, a heat transfer coefficient of about 8 W/m²K can be expected as a heat transfer coefficient of the surface.

The area of the LED module is 0.2 m×0.2 m=0.04 m². Therefore, thermal radiation of (8 W/m²K)×0.04 m²=0.32 W/m²K per a temperature rise of 1° C. can be realized.

Therefore, a temperature rise that occurs when electric power of 15.5 W is input is calculated as 15.5 W/(0.32 W/m²K)=48.4° C.

When ambient temperature is set to 30° C. and the temperature rise value of 48.4° C. is added, the surface temperature of the LED module 1 is assumed to be 78.4° C. The temperature is not excessively high and considered to be a permissible value.

Therefore, it is unnecessary to provide a particular radiator. Even if a radiator is provided, it is possible to adopt a simplified configuration.

### [Electrical Connection of the LED Module]

When maximum eight LED modules 1 are connected in series, a circuit voltage equal to or lower than 300 V is set as a reference and, when maximum four LED modules 1 are connected in series, a circuit voltage equal to or lower than 150 V is set as a reference, a voltage of one LED module 1 is set as 35 V and a standard current is specified. Specifically, maximum power is 15.5 W/35V≈450 mA. The standard current can be specified as 450 mA.

The LED module 1 according to this embodiment is designed based on the technical ground explained above. Therefore, the LED module 1 is easily handled in terms of size and can be disposed to correspond to the size of a luminaire having the existing fluorescent lamp as a light source. Since the LED module 1 has compatibility with the existing fluorescent lamp in terms of performance, there is an effect that the LED module 1 can be replaced with the existing fluorescent lamp and is easily used in common. Specifically, the LED modules 1 can realize a lighting effect equivalent to the lighting effect of a light source in luminaires for two lamps of fluorescent lamp FLR type 40 W to two lamps (high-power lighting) of Hf type 32 W.

Lighting design same as the luminaire having the existing fluorescent lamp as the light source can be performed and efficiency of design can be realized.

Further, since an excessive temperature rise does not occur in the LED module 1, it is unnecessary to provide a particular radiator. It is possible to prevent an excessive temperature rise of the LED 3. A thermal radiation structure for improvement of heat dissipation is not prevented from being adopted.

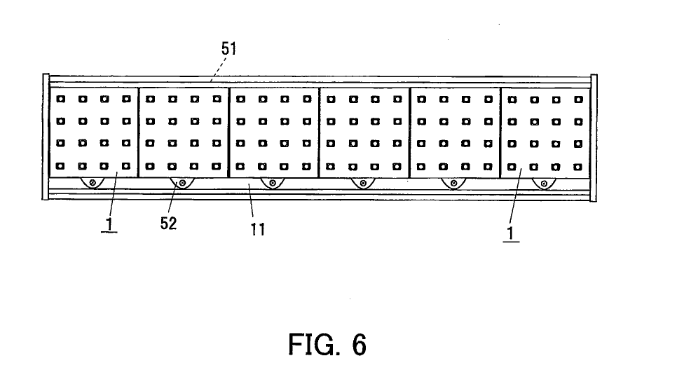

A luminaire in which the LED modules 1 are disposed is explained with reference to FIGS. 4 to 8. FIG. 4 is a perspective view of the luminaire. FIG. 5 is a disassembled perspective view of the luminaire. FIG. 6 is a front view of the luminaire from which a cover member is removed. FIG. 7 is a perspective view of an LED module unit. FIG. 8 is a perspective view of an attachment configuration of the LED module 1.

In FIGS. 4 and 5, a luminaire of a ceiling mounting type set on the ceiling surface is shown. The luminaire includes an equipment main body 10 formed in a laterally long substantially rectangular parallelepiped shape of a 4-feet size and the LED modules 1 disposed on the equipment main body 10. The LED modules 1 are attached to an attachment plate 11, which is an attachment member.

Specifically, the equipment main body 10 is formed of a zinc coated steel sheet. The equipment main body 10 includes a top plate section 12 formed in a substantially rectangular shape and a gutter shape having sidewalls on both sides in a longitudinal direction, frame members 13 attached to both the sides along the longitudinal direction of the top plate section 12, and side plates 14 attached to both ends of the top plate section 12.

The attachment plate 11 is formed of an aluminum material or the like in a substantially rectangular shape and is attached in the equipment main body 10. The attachment plate 11 may be formed of a synthetic resin material.

Six LED modules 1 are arranged in the longitudinal direction of the luminaire and attached to the attachment plate 11.

As shown in FIGS. 7 and 8, the LED module 1 is held by a holding member 5 of a substantially quadrangular shallow box shape formed of metal, synthetic resin, or the like. Therefore, the LED module 1 and the holding member 5 configure an LED module unit 4 functioning as a light-emitting module unit.

A pair of locking pieces 51 are formed on both sides on the rear surface side on one side of the holding member 5. A fixing piece 52 is formed in substantially the center on the other side opposed to the one side of the holding member 5. The locking pieces 51 are provided on the side of one side of the LED module 1 to project in the outer side direction. The fixing piece 52 is provided on the side of the other side, which is the side of the opposed side opposed to the side of the one side, of the LED module 1 to project in the outer side direction.

The locking pieces 51 have a substantially square claw shape and are formed to project in the outer side direction. The fixing piece 52 is formed in an arc shape at the distal end. The fixing piece 52 includes a screw through-hole 52a through which an attachment screw 52b functioning as fixing means pierces. The fixing piece 52 is formed to project in the outer side direction.

A power-receiving side connector C1 and a power-feeding side connector (for power feeding) C2 are provided on the side of the other side of the LED module 1. A lead-in hole 53 and a lead-out hole 54 for a lead wire or the like are formed on a side of the holding member 5 to be opposed to the power-receiving side connector C1 and the power-feeding side connector (for power feeding) C2.

A lead wire led out from a power supply side or the LED module unit 4 adjacent to the LED module unit 4 is led into the lead-in hole 53. The lead wire is connected to the power-receiving side connector C1. A lead wire connected to the power-feeding side connector (for power feeding) C2 and having a connection connector C3 at the distal end portion is lead out from the lead-out hole 54. The lead wire is connected to the power-receiving side connector C1 of the adjacent LED module unit 4. In this way, the adjacent LED module units 4 are sequentially electrically connected.

As shown in FIG. 8, the LED module unit 4 configured in this way is attached to the attachment plate 11 on the equipment main body 10 side. A sidewall standing toward the front surface side is formed in the attachment plate 11. Locking holes 11a functioning as insertion sections are formed in the sidewall to be opposed to the locking pieces 51 of the holding member 5. The locking holes 11a are elongated holes formed in size substantially the same as the size of the locking pieces 51. The locking pieces 51 are inserted into the locking holes 11a. A plurality of such locking holes 11a are formed on one side of the attachment plate 11 along the longitudinal direction such that the LED module units 4 are provided in parallel and the locking pieces 51 of the LED module units 4 can be locked.

As a specific attaching method, the locking pieces 51 of the holding member 5 are inserted into the locking holes 11a of the attachment plate 11 and locked. Thereafter, the attachment screw 52b is pierced through the through-hole 52a and screwed into a screw hole on the attachment plate 11 side. A circumferential portion of the screw hole of the attachment plate 11 is equivalent to a fixing section 11c in which the fixing piece 52 is fixed by the attachment screw 52b.

Consequently, the LED module 1 can be easily positioned, attached to the attachment plate 11 on the equipment main body 10 side, and mechanically held. The LED module 1 may be electrically connected simultaneously with being mechanically held.

As shown in FIG. 5, a lighting device 15 is attached on the inner side of the top plate section 12 of the equipment main body 10. The lighting device 15 is configured with circuit components stored in a box-like case. The lighting device 15 is connected to a commercial alternating-current power supply AC. The lighting device 15 receives the alternating-current power supply AC and generates a direct-current output. The lighting device 15 is configured, for example, with a smoothing capacitor connected between output terminals of a full-wave rectifier circuit and with a direct-current voltage converting circuit and current detecting means connected to the smoothing capacitor. Therefore, the lighting device 15 is connected to the LED module 1 and supplies a direct-current output of the lighting device 15 to the LED 3 to control lighting of the LED 3.

A translucent cover member 16 is attached to the front surface side of the equipment main body 10 to cover the LED module unit 4. The cover member 16 is formed of acrylic resin or the like in a rectangular shape and is subjected to diffusion treatment to have a function of diffusing lights emitted from the LED modules 1.

When electric power is supplied to the lighting device 15 in a set state of the luminaire, the LED modules 1 are energized and the LEDs 3 are lit. At power consumption equal to or less than 16 W, the LED modules 1 emit lights with a luminous flux of 700 lm to 1300 lm. The emitted lights are transmitted through the translucent cover member 16 and emitted downward to irradiate a predetermined range.

Heat generated from the LED modules 1 is radiated from the surfaces of the LED modules 1. In addition, the heat is transmitted to the attachment plate 11 and radiated. Therefore, it is possible to effectively suppress a temperature rise of the LED modules 1. In this case, even if the attachment plate 11 is formed of a synthetic resin material having low heat conductivity, since the heat is radiated from the surfaces of the LED modules 1, it is possible to prevent an excessive temperature rise.

With the luminaire having such a configuration, it is possible to obtain a lighting effect equivalent to the lighting effect of the luminaires for two lamps of fluorescent lamp FLR type 40 W to two lamps of Hf type 32 W (high-output lighting). When the LED modules 1 are attached to the equipment main body 10, since the LED modules 1 are easily positioned and attached, it is possible to realize efficiency of assembly work.

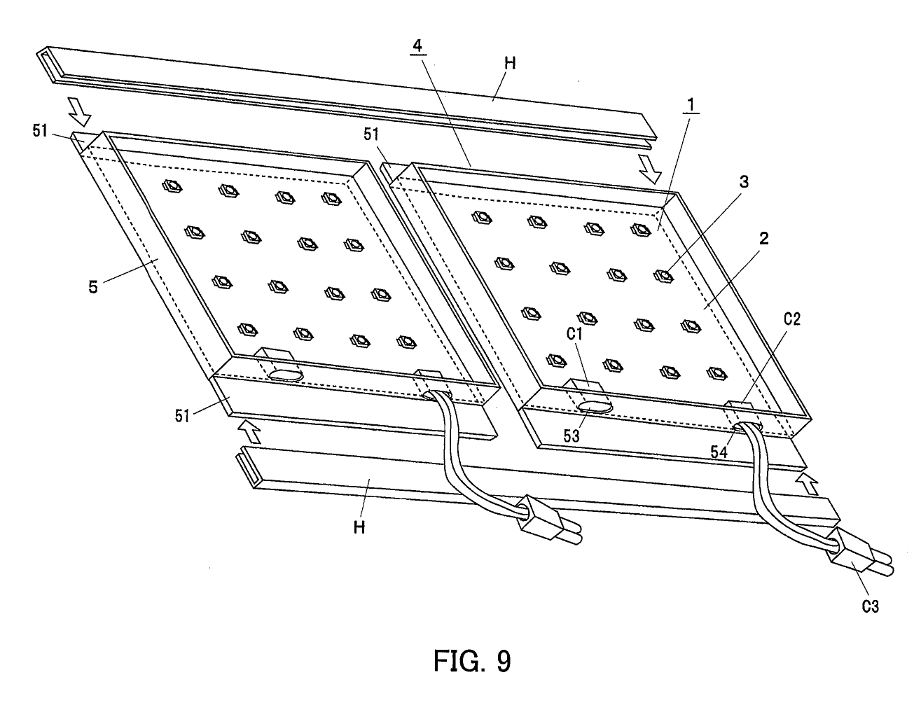

Examples of other attachment configurations in the LED module 1 are explained with reference to FIGS. 9 to 14. Components same as the components in the first embodiment are denoted by the same reference numerals and signs and redundant explanation of the components is omitted.

### Example 1

As shown in FIG. 9, the locking pieces 51 having a flange shape projecting in the outer side direction are formed on both sides of the holding member 5 of the LED module unit 4.

Holding materials H having a C shape in cross section that hold the locking pieces 51 of the plural LED module units 4 from both the sides are used.

Therefore, the plural LED modules 1 can be linearly arranged and held by the holding materials H. The plural LED modules 1 can be attached on the equipment main body 10 side in this holding state. The LED module units 4 may be electrically connected simultaneously with being mechanically held by the holding materials H.

### Example 2

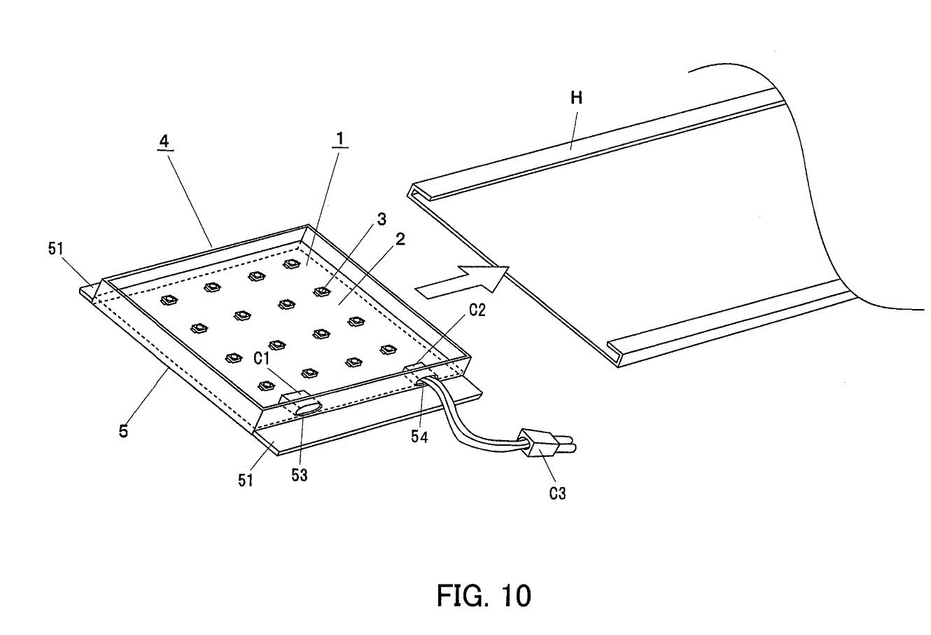

As shown in FIG. 10, the LED module unit 4 in an example 2 is the same as the LED module unit 4 in the example 1. The holding material H is formed in a rail shape and formed in a C shape in cross section at both ends. The locking pieces 51 of the LED module unit 4 are disposed to be slid into the holding material H.

Therefore, in this case, as in the example 1, the plural LED modules 1 can be linearly arranged and held and can be attached to the equipment main body 10 side. The holding material H may be integrally formed on the equipment main body 10 side.

### Example 3

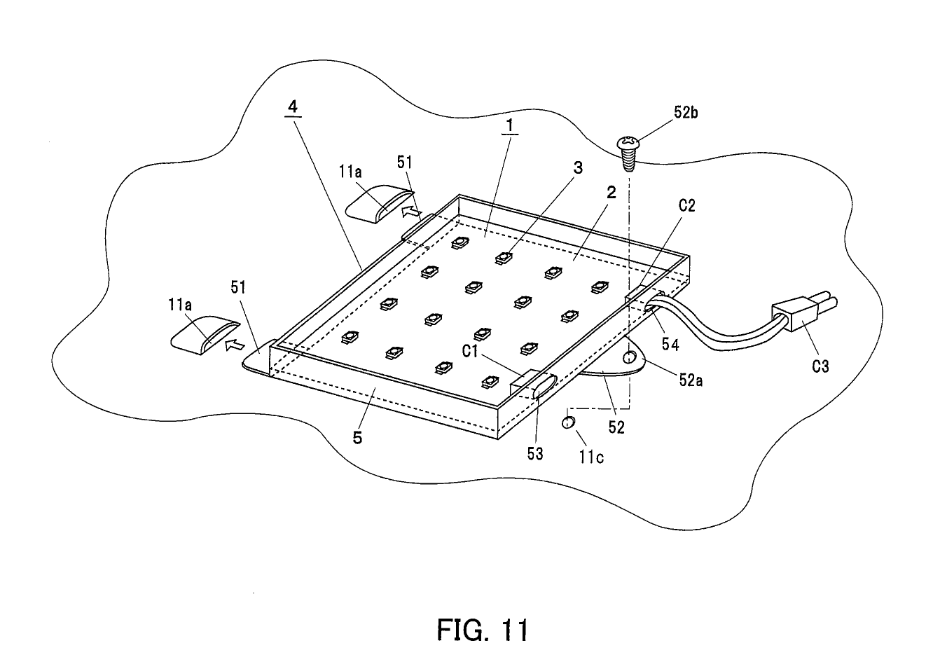

As shown in FIG. 11, the LED module unit 4 in this example has a configuration same as the configuration in the first embodiment. The pair of locking pieces 51 are formed on both sides on one side of the holding member 5. The fixing piece 52 is formed on the other side opposed to the one side.

On the other hand, the locking holes 11a formed by being deformed to bulge to the front surface side by cutting are formed in the attachment plate 11. The locking holes 11a are provided in places opposed to the locking pieces 51 of the holding member 5. The locking pieces 51 are inserted into the locking holes 11a and locked and the attachment screw 52b is pierced through the screw through-hole 52a and screwed into the screw hole on the attachment plate 11 side, whereby the LED module 1 is mechanically held by the attachment plate 11.

Therefore, since the LED module 1 can be easily positioned and attached, it is possible to realize efficiency of assembly work.

### Example 4

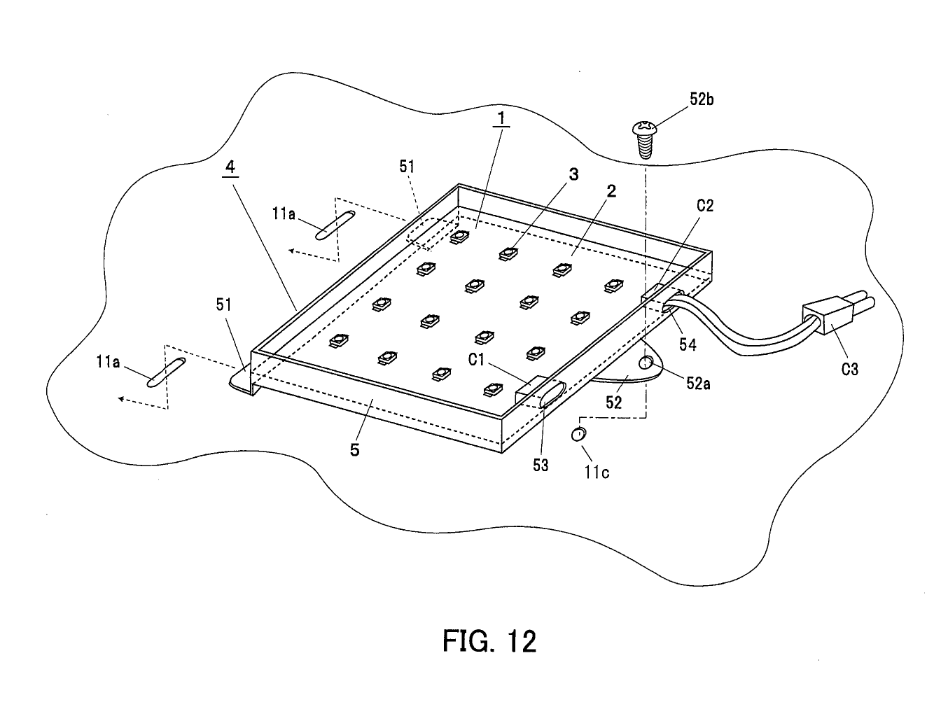

As shown in FIG. 12, the LED module unit 4 in an example 4 has a configuration same as the configuration in the first embodiment. However, the locking pieces 51 of the holding member 5 slightly extend in the rear surface side on one side and are formed in a substantially L shape in cross section. On the other hand, the elongated locking holes 11a are formed on the plane of the attachment plate 11.

With such a configuration, the locking pieces 51 can be locked to the locking holes 11a by first inserting the locking pieces 51 in the lower side direction and then moving the locking pieces 51 in the horizontal direction in the figure. The LED module 1 is mechanically held on the attachment plate 11 by piercing the attachment screw 52b through the screw through-hole 52a and screwing the attachment screw 52b into the screw hole on the attachment plate 11 side.

Therefore, since the LED module 1 can be easily positioned and attached, it is possible to realize efficiency of assembly work.

### Example 5

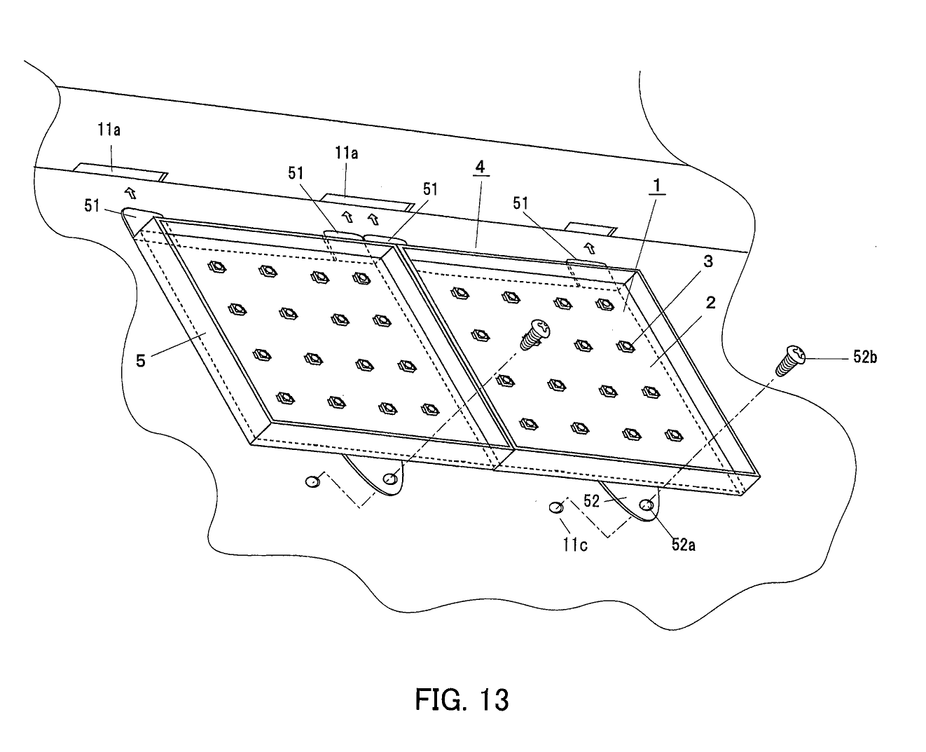

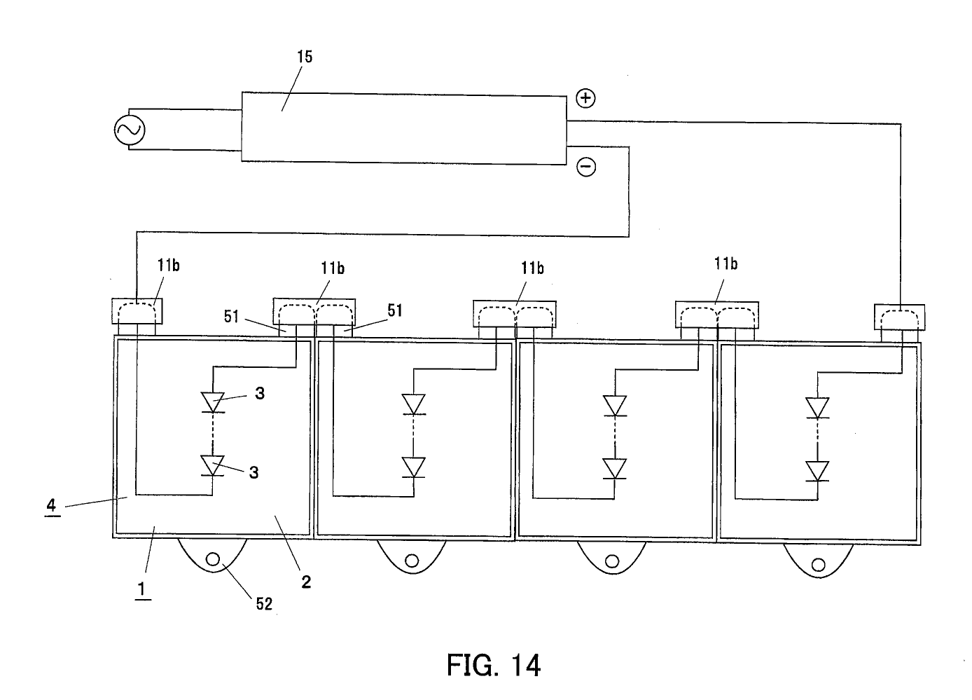

As shown in FIGS. 13 and 14, in an example 5, a specific configuration for mechanically holding and electrically connecting the LED module 1 by locking the locking pieces 51 to the locking holes 11a is explained. FIG. 14 is an electrical connection diagram.

Therefore, in this example, the locking pieces 51 function as conductive terminals having conductivity. The locking pieces 51 are electrically connected to the LEDs 3 via a wiring pattern formed on the substrate 2.

The locking pieces 51 adjacent to the equipment main body 10 are inserted into the attachment plate 11 on the equipment main body 10 side. In other words, the locking holes 11a having size enough for inserting the two locking pieces 51 are formed. Conductive tongue pieces 11b are disposed on the inner side of the locking holes 11a (see FIG. 14).

As shown in FIG. 14, four LED modules 1 are provided in parallel and arranged. The locking pieces 51 of the LED module units 4 adjacent to one another are inserted into the locking holes 11a, the locking pieces 51 come into contact with the conductive tongue pieces 11b, and the locking pieces 51 adjacent to one another are electrically connected. Therefore, the four LED modules 1 are connected in series.

An anode side terminal and a cathode side terminal of the lighting device 15 are connected to the locking pieces 51 on the outer end side of the LED module unit 4 located on both end sides. Electric power is supplied from the lighting device 15 to the LED modules 1 connected in series.

The locking pieces 51 may be directly provided at an end of the substrate 2 in the LED module 1.

With such a configuration, it is possible to simultaneously perform mechanical holding and electrical connection of the LED module 1 by locking the locking pieces 51 to the locking holes 11a.

As explained above, according to this example, the configuration realizes both the mechanical holding and the electrical connection. Therefore, it is possible to further improve efficiency of assembly work. In electrically connecting the LED modules 1, it is possible to make connection by a connector or the like unnecessary and reduce cost.

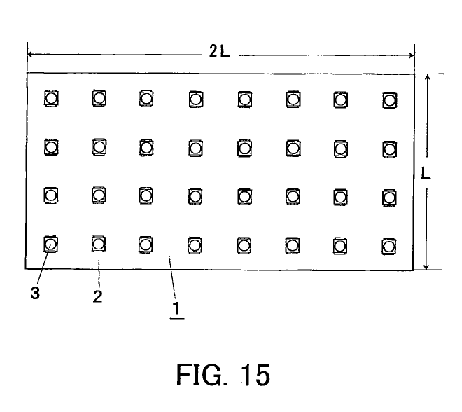

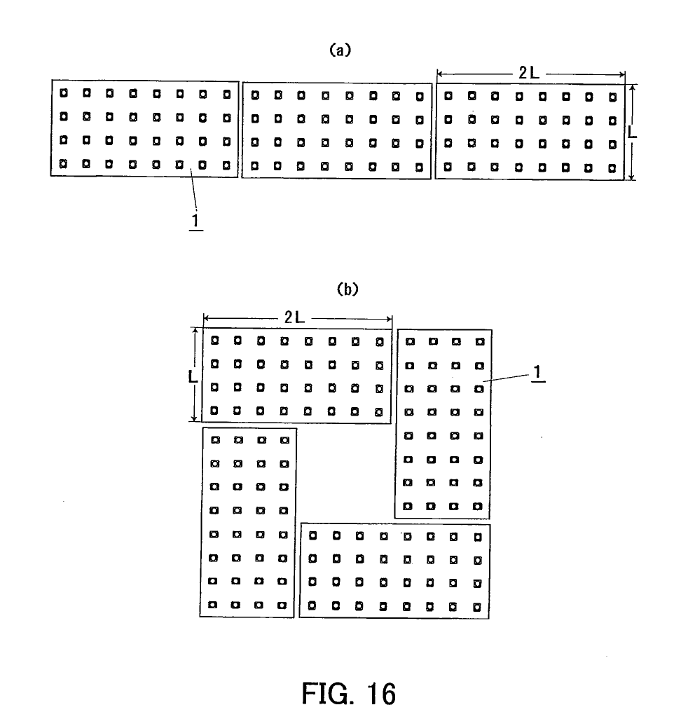

A second embodiment is explained with reference to FIG. 15 and FIGS. 16(a) and 16(b). Components same as or equivalent to the components in the first embodiment are denoted by the same reference numerals and signs and redundant explanation of the embodiments is omitted.

As shown in FIG. 15, the LED module 1 according to this embodiment is formed in a rectangular shape, a length dimension in the longitudinal direction of which is twice as large as the unit dimension L. Specifically, the length dimension in the longitudinal direction is 320 mm to 400 mm, which is twice (2 L) as large as the unit dimension of 160 mm to 200 mm. In this case, as in the first embodiment, an optical output per a square having the unit dimension L as a length dimension of one side is 700 lm to 1300 lm and rated power consumption is equal to or less than 16 W.

Therefore, in order to adapt the LED module 1 to a laterally long rectangular base light, as shown in FIG. 16(a), three LED modules 1 can be arranged in the longitudinal direction to configure the base light. In order to adapt the LED module 1 to a square base light as shown in FIG. 16(b), four LED modules 1 can be arranged in a quadrangular shape to configure the base light.

As explained above, according to this embodiment, it is possible to realize effects same as the effects in the first embodiment. It is possible to provide the LED module 1 that has compatibility with the existing fluorescent lamp in terms of performance and can be easily used in common in various luminaires.

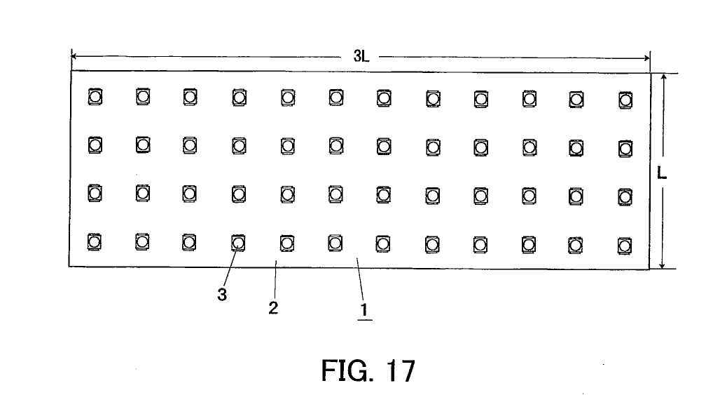

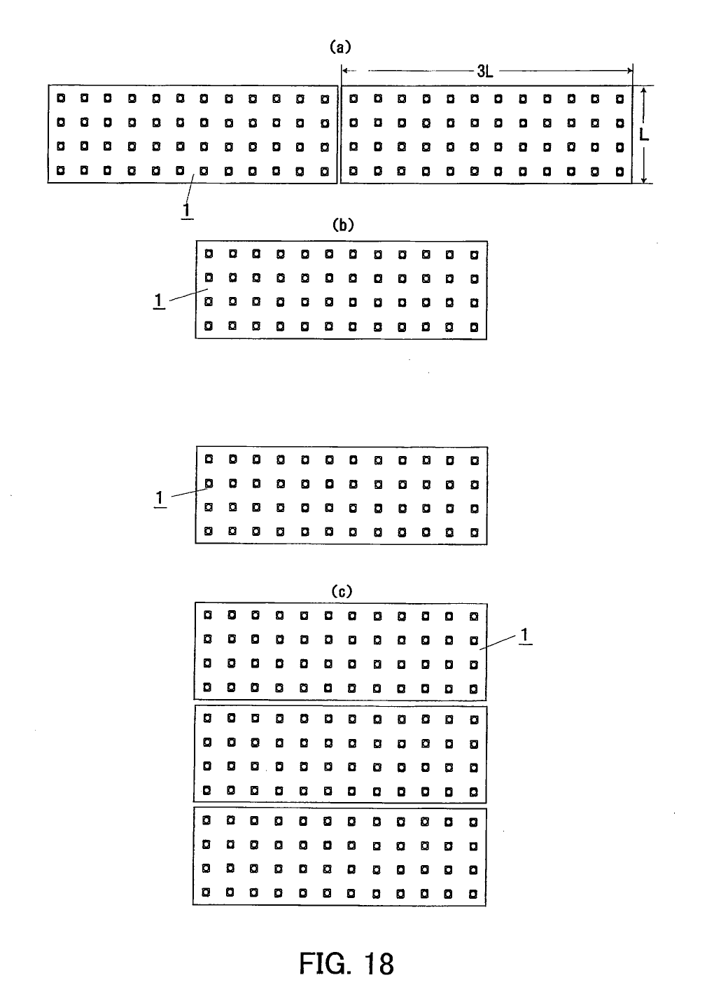

A third embodiment is explained with reference to FIG. 17 and FIGS. 18(a) to 18(c). Components same as or equivalent to the components in the first embodiment are denoted by the same reference numerals and sings and redundant explanation of the components is omitted.

As shown in FIG. 17, the LED module 1 according to this embodiment is formed in a rectangular shape, a length dimension in the longitudinal direction of which is three times as large as the unit dimension L. Specifically, the length dimension in the longitudinal direction is 480 mm to 600 mm, which is three times (3 L) as large as the unit dimension of 160 mm to 200 mm. In this case, as in the first embodiment, an optical output per a square having the unit dimension L as a length dimension of one side is 700 lm to 1300 lm and rated power consumption is equal to or less than 16 W.

Therefore, in order to adapt the LED module 1 to a laterally long rectangular base light, as shown in FIG. 18(a), two LED modules 1 can be arranged in the longitudinal direction to configure the base light. In order to adapt the LED module 1 to a square base light as shown in FIG. 18(b), two LED modules 1 can be arranged in a space apart from each other in a direction orthogonal to the longitudinal direction to configure the base light. In this case, as shown in FIG. 18(c), three LED modules 1 can be arranged without a space in the direction orthogonal to the longitudinal direction to configure the base light.

As explained above, according to this embodiment, it is possible to realize effects same as the effects in the first embodiment. It is possible to provide the LED module 1 that has compatibility with the existing fluorescent lamp in terms of performance and can be easily used in common in various luminaires.

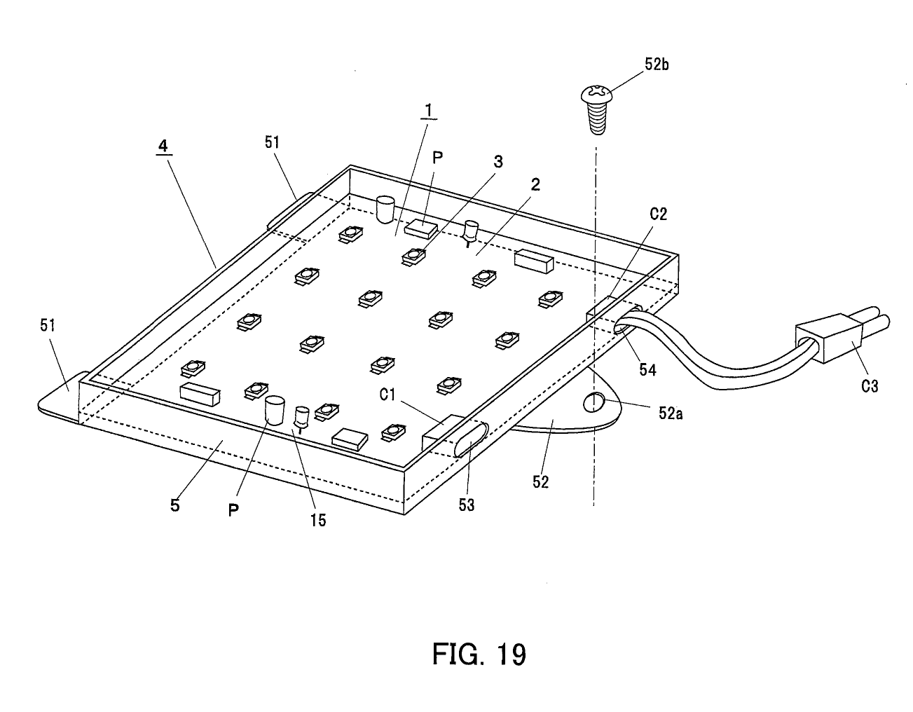

A fourth embodiment is explained with reference to FIG. 19. Components same as or equivalent to the components in the first embodiment are denoted by the same reference numerals and sings and redundant explanation of the components is omitted.

The configuration of the holding member 5, i.e., the configuration of the locking pieces 51 and the fixing pieces 52 is the same as the configuration in the example 5 shown in FIGS. 13 and 14.

Lighting circuit components P having a function of the lighting device 15 are mounted on the outer periphery on the surface of the LED module 1. Therefore, a direct-current output is supplied to the LEDs 3 by the lighting device 15 and the LEDs 3 are controlled to be lit.

It is possible to simultaneously perform mechanical holding and electrical connection of the LED module 1 by locking the locking pieces 51 of such an LED module unit 4 to the locking holes 11a. In this case, since the lighting device 15 is provided in the LED module 1, it is possible to control to light the LED 3 by supplying commercial power to the LED module unit 4.

As a light-emitting element, a solid-state light-emitting element such as an LED or an organic EL can be applied. When the light-emitting element is mounted on a substrate, the light-emitting element could be mounted in a surface mounting system or could be directly mounted on the substrate. The number of light-emitting elements to be mounted is not specifically limited.

The attachment member includes members referred to as a main body, a case, a reflection plate, a chassis, and the like of the luminaire. In short, the attachment member means members and sections to which the light-emitting module unit 1 is attached.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

1-13. (canceled)

14. A light-emitting module comprising:
a substrate; and
a light-emitting element mounted on the substrate, wherein
one side of the light-emitting module has a length of 160 mm to 200 mm, and
an optical output per area for a square section of the light-emitting module having a side length equal to the length of the one side of the light-emitting module is 700 lm to 1300 lm and a rated power consumption of the square section is equal to or less than 16 W.

15. The module according to claim 14, wherein the light-emitting module is formed in a square shape.

16. The module according to claim 14, wherein the light-emitting module is formed in a rectangular shape having another side whose length is twice that of the one side.

17. The module according to claim 14, wherein the light-emitting module is formed in a rectangular shape having another side whose length is three times that of the one side.

18. The module according to claim 14, further comprising a lighting device configured to light the light-emitting element, which is mounted on the substrate.

19. A lighting unit comprising:
the light-emitting module according to claim 14;
a locking piece that projects outwardly from one side of the light-emitting module; and
a fixing piece that projects outwardly from another side of the module that is opposite the one side.

20. The unit according to claim 19, wherein the locking piece is configured to provide mechanical holding and electrical connection.

21. A luminaire comprising:
an equipment main body; and
a light-emitting module disposed in the equipment main body and including a substrate and a light-emitting element mounted on the substrate, one side of the light-emitting module having a length of 160 mm to 200 mm, an optical output per area for a square section of the light-emitting module having a side length equal to the length of the one side of the light-emitting module being 700 lm to 1300 lm, and a rated power consumption of the square section being equal to or less than 16 W.

22. The luminaire according to claim 21, wherein a plurality of the light-emitting modules are arranged in sufficient numbers and in a pattern to provide a shape and lighting performance equivalent to a shape and lighting performance of a luminaire including a fluorescent lamp as a light source.

23. The luminaire according to claim 21, wherein a plurality of the light-emitting modules are linearly arranged to form a rectangular shape.

24. The luminaire according to claim 21, wherein a plurality of the light-emitting modules are arranged in a quadrangular shape to form a square shape.

25. A luminaire comprising:
a light-emitting module unit including:
a light-emitting module including a substrate and a light-emitting element mounted on the substrate, one side of the light-emitting module having a length of 160 mm to 200 mm and an optical output per area for a square section of the light-emitting module having a side length equal to the length of the one side being 700 lm to 1300 lm, and a rated power consumption of the square section being equal to or less than 16 W;
a locking piece that projects outwardly from one side of the light-emitting module; and
a fixing piece that projects outwardly from another side of the light-emitting module that is opposite the one side; and
an attachment member including a groove region into which the locking piece of the light-emitting module unit is inserted and a fixing section to which the fixing piece of the light-emitting module is fixed.

26. The luminaire according to claim 25, wherein
a plurality of the light-emitting module units are arranged in parallel and attached to the attachment member, and
each locking piece and fixing piece of the light-emitting module units extend outwardly in a direction that is orthogonal to a direction along which the light-emitting module units are arranged.

27. A luminaire comprising:
an equipment main body; and
one or more light-emitting modules each disposed in the equipment main body and including a substrate on which a plurality of light-emitting elements are arranged on the substrate in a grid pattern,
wherein an optical output per area for a square section of the light-emitting module having a side length equal to 160 mm to 200 mm is 700 lm to 1300 lm, and a rated power consumption of the square section is equal to or less than 16 W.

28. The luminaire according to claim 27, wherein a plurality of the light-emitting modules are arranged in a linear array.

29. The luminaire according to claim 27, wherein a plurality of the light-emitting modules are arranged in a quadrangular shape to form a square shape.
